(19) United States
(12) Patent Application Publication
(10) Pub. No.: US 2019/0077597 A1
(43) Pub. Date: Mar. 14, 2019

(54) STORAGE AND RETRIEVAL SYSTEM

(71) Applicant: Pushkraj Janwadkar, Kolhapur (IN)

(72) Inventor: Pushkraj Janwadkar, Kolhapur (IN)

(21) Appl. No.: 16/083,759

(22) PCT Filed: Mar. 10, 2017
(86) PCT No.: PCT/IN2017/000057

§ 371 Date: Sep. 10, 2018

(30) Foreign Application Priority Data
Mar. 10, 2016 (IN) 201621008478

(51) Int. Cl. B65G 1/12; G06K 7/04

(52) U.S. Cl. CPC B65G 1/12; G06K 7/042

(57) ABSTRACT

The storage and retrieval system includes an enclosure housing multiple carousel assemblies mounted on the top of each other, a control system, a first set of drive mechanisms, a second set of drive mechanisms, and an authentication device. The control system receives input and user identification information from the user from the authentication device and stores it in a memory. During storage access, the control system identifies an available storage compartment that is nearest to the door of the enclosure and allocates it for the user. During retrieval access, the control system identifies the allocated compartment to the user. The control system then monitors the drive system to rotate the corresponding carousel assembly so that the allocated storage compartment is positioned in front of the door of the enclosure. The control system then unlocks the door and the user can access the storage compartment.

### FIELD OF INVENTION

The present invention relates generally to storage systems, and more particularly, to storage systems with secure user access.

### BACKGROUND

Conventional storage systems are immobile and are operated manually. It is inconvenient for a user to remember storage locations and access goods stored in the storage systems. Hence, conventional storage systems are automated to facilitate storage and retrieval of the goods. Further, automated storage systems reduce the time and the errors while storing and retrieving the goods.

A known technique is cited in U.S. Pat. No. 8,145,351 B2, in which a storage system includes an enclosure that includes a plurality of compartments for storing goods, a drive system, a sensor, a control system, and a safety system. An input from a user is taken by way of an interface. The control system ensures a secure access to the multiple compartments based on a password which the user enters before storing or retrieving objects from at least one of the multiple compartments. Further, the control system determines the compartment which is required for storing or retrieving of objects based on the input from the user. The enclosure has a door or an opening that can be opened for storing objects in the required compartment. The control system controls the drive system to rotate the carousel in order to position the required compartment in front of the door of the enclosure. The process of opening and locking the door is automated using a sensor. The control system controls the automatic locking of the door using the sensor, thereby ensuring safety of the user. However, the storage system fails to allocate a compartment that is available for use as it always provides access to a compartment requested by the user. Even though the requested compartment is farther from the door than a compartment that is available near the door, the storage system provides access to the compartment requested by the user, thereby resulting in an unnecessary delay in accessing the compartments. The mechanisms required to operate the storage system are complicated mechanisms that lead to a substantial increase in production costs. Another drawback is that the storage system is not portable.

In light of the foregoing discussion, it would be advantageous to have a portable storage and retrieval system that provides a user an authorized access to multiple storage compartments, that is highly portable, and that ensures minimum time required to access the storage compartment.

### SUMMARY OF THE INVENTION

A storage device for storing and subsequent retrieval of goods includes a carousel assembly that includes a plurality of storage compartments arranged around a central axis. The carousel assembly is housed in an enclosure. The enclosure has a door that allows access to one of the plurality of storage compartments at an instant of time. A first drive mechanism is mounted in the enclosure for rotating the carousel assembly. A second drive mechanism is also mounted in the enclosure for opening and closing the door. An authentication device is attached to the enclosure for authenticating a user prior to storing and retrieving the goods. A control system is connected to the first drive mechanism, the second drive mechanism, and the authentication device for controlling the movements of the door and the carousel assembly. When the user is authenticated for storing goods in the storage device, the control system determines a displacement of each of the plurality of storage compartments from a storage compartment that is at a home position and dynamically allocates at least one storage compartment of the plurality of storage compartments to the user.

The storage and retrieval system includes an enclosure housing multiple carousel assemblies mounted on the top of each other, a control system, a first set of drive mechanisms, a second set of drive mechanisms, and an authentication device. The control system receives input and user identification information from a user through the authentication device and stores it in a memory. During storage access, the control system identifies an available storage compartment that is nearest to the door of the enclosure and allocates it for the user. During retrieval access, the control system identifies the allocated storage compartment to the user. The control system then monitors the drive system to rotate the corresponding carousel assembly so that the allocated storage compartment is positioned in front of the door of the enclosure. The control system then unlocks the door and the user can access the storage compartment.

The storage compartments are equipped with wireless chargers for charging stored electronic devices such as mobile phones.

### BRIEF DESCRIPTION OF DRAWINGS

The invention is described in detail below with reference to the drawings and examples. Such discussion is for purposes of illustration only. Modifications within the spirit and scope of the present invention, set forth in the appended claims, will be readily apparent to one of skill in the art. Terminology used throughout the specification and claims herein is given its ordinary meaning except as more specifically defined:

FIG. 1A is a schematic diagram of a storage and retrieval system in accordance with an embodiment of the present invention;

FIG. 1B is a schematic diagram of a side view of the storage and retrieval system of FIG. 1A in accordance with an embodiment of the present invention;

FIG. 1C is a schematic diagram of a top view of the storage and retrieval system of FIG. 1A in accordance with an embodiment of the present invention; and

FIG. 1D is a schematic diagram of the first carousel assembly of the storage and retrieval system of FIG. 1A in accordance with an embodiment of the present invention.

### DETAIL DESCRIPTION OF EMBODIMENTS

As used in the specification and claims, the singular forms “a”, “an” and “the” include plural references unless the context clearly dictates otherwise. For example, the term “an article” may include a plurality of articles unless the context clearly dictates otherwise.

Those with ordinary skill in the art will appreciate that the elements in the Figures are illustrated for simplicity and clarity and are not necessarily drawn to scale. For example, the dimensions of some of the elements in the Figures may be exaggerated, relative to other elements, in order to improve the understanding of the present invention.

There may be additional components described in the foregoing application that are not depicted on one of the described drawings. In the event such a component is described, but not depicted in a drawing, the absence of such a drawing should not be considered as an omission of such design from the specification.

Before describing the present invention in detail, it should be observed that the present invention utilizes a combination of system components which constitutes a storage and retrieval system. Accordingly, the components and the method steps have been represented, showing only specific details that are pertinent for an understanding of the present invention so as not to obscure the disclosure with details that will be readily apparent to those with ordinary skill in the art having the benefit of the description herein.

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

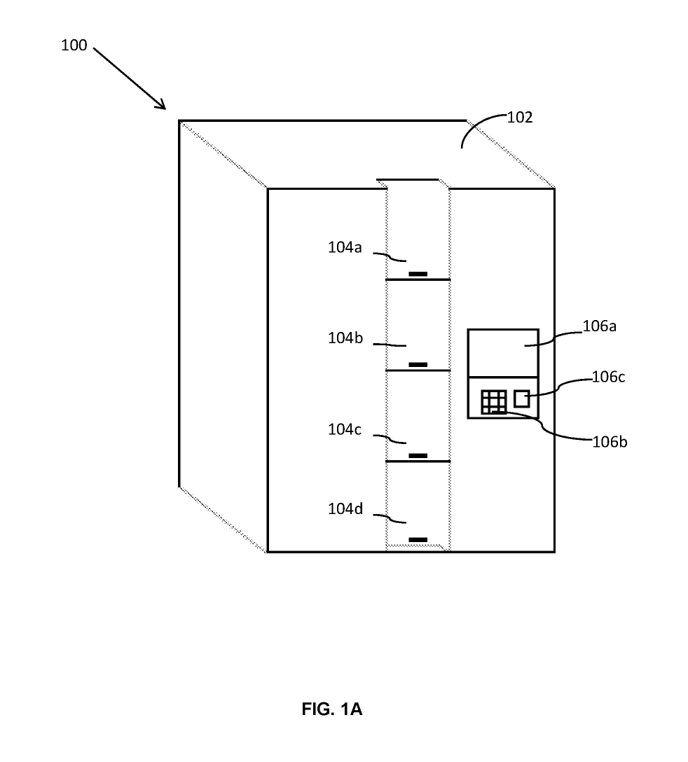

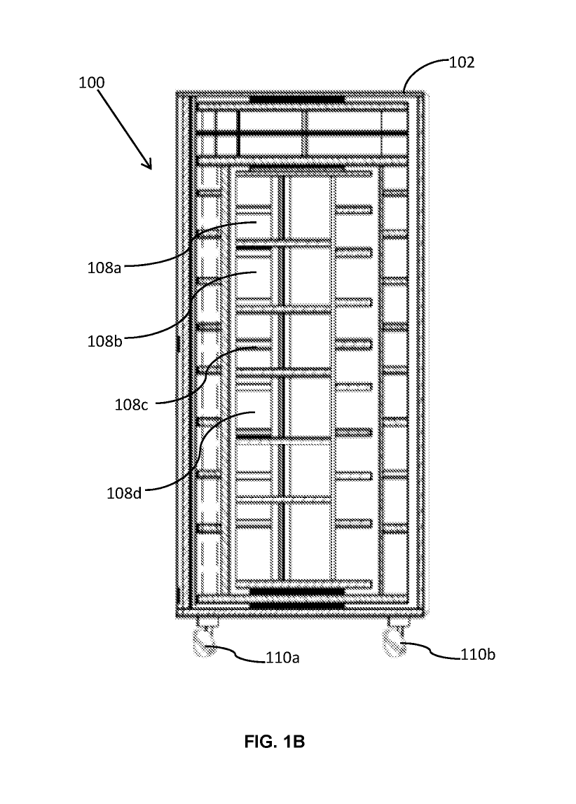

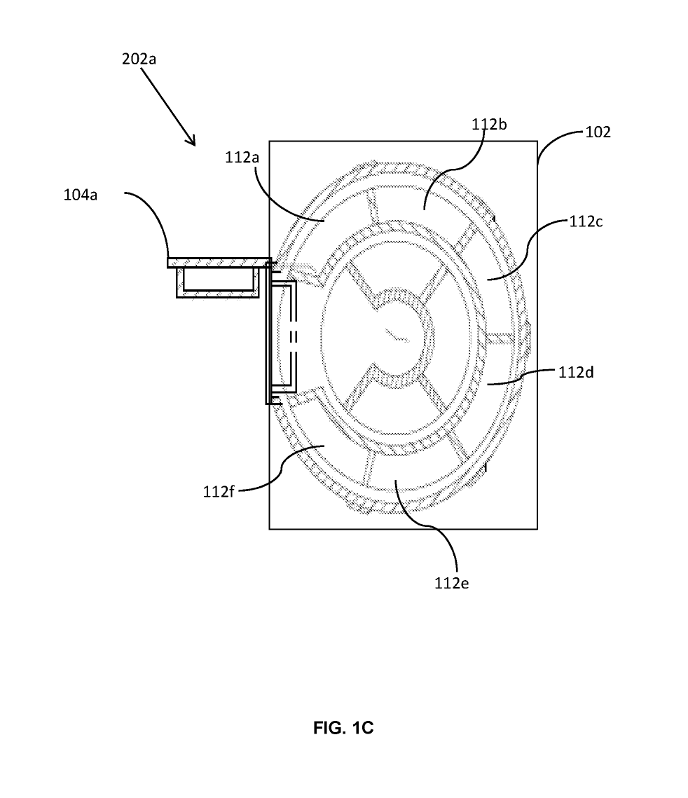

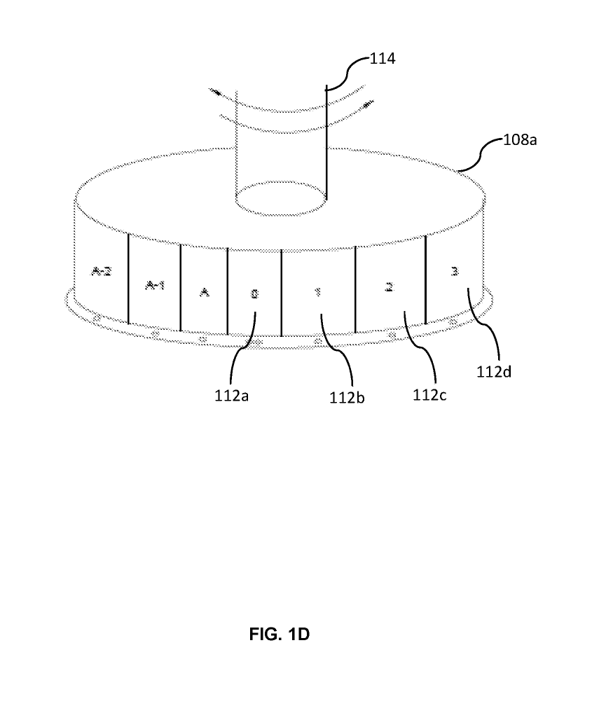

Referring now to FIG. 1A, a schematic diagram of a storage and retrieval system 100 is shown. The storage and retrieval system 100 includes an enclosure 102 that includes a plurality of doors 104—four of which are shown—first through fourth doors 104a-104b. In an embodiment, the enclosure 102 includes a display device 106a, an input device 106b, and an authentication device 106c.

The display device 106a, the input device 106b, and the authentication device 106c are placed on the enclosure 102 at a position which can be easily accessed by a user. The input device 106b allows the user to request for at least one of a storage access and a retrieval access. In an embodiment, the input device 106b is an alpha-numeric keypad. In another embodiment, the display device 106a is a digital display or an LCD screen. In yet another embodiment, the display device 106a and the input device 106b are together implemented using a touch screen.

The user provides user identification information by way of the authentication device 106c. The authentication device converts the user identification information into electrical signals. In an embodiment, the user identification information is a password or a biometric input or a combination of both. In another embodiment, the authentication device 106c is a biometric device such as a finger-print scanner, an eye scanner, a microphone, and a camera. In yet another embodiment, the authentication device 106c is a barcode generator and scanner. At the time of storage, the barcode generator generates a chip or a stripe of paper with a barcode. At the time of retrieval, the barcode scanner scans the chip or the stripe of paper that is in possession of the user. In yet another embodiment, the authentication device 106c allows user to set password against a corresponding compartment. In yet another embodiment, the authentication device 106c may be one of printed magnetic card, credit/debit cards, and cash collection system with tokens.

As shown in FIG. 1B, a schematic diagram of a side view of the storage and retrieval system 100 in accordance with an embodiment of the present invention discloses the enclosure 102 housing a plurality of carousel assemblies 108—four of which are shown—first through fourth carousel assemblies 108a-108d corresponding to the first through four doors 104a-104d, a first set of drive mechanisms (not shown), a second set of drive mechanisms (not shown), and a control system (not shown).

Each of the first set of drive mechanisms comprises a motor (not shown) corresponding to a carousel assembly of the plurality of carousel assemblies 108. Each motor is connected to the corresponding carousel assembly and electrically connected to the processor so that the processor can drive the motor to rotate the corresponding carousel assembly. The motor rotates the corresponding carousel assembly independent of the remaining carousel assemblies. In an embodiment, each motor is a stepper motor or a servo motor. In another embodiment, the processor is a micro-processor.

The motor rotates the corresponding carousel assembly. Each of the second set of drive mechanisms has a mechanism that opens and closes the corresponding door of the plurality of doors 104. The control system comprises a processor (not shown) and a memory (not shown). The control system is connected to the first set of drive mechanisms, the second set of drive mechanisms, and the authentication device 106c. In an embodiment, the processor may be a PLC controller.

Referring now to FIG. 1C, a top view of the storage and retrieval system 100 shows the first carousel assembly 108a including a plurality of storage compartments 112—six of which are shown—first through sixth storage compartments 112a-112f In an embodiment, the first through sixth storage compartments 112a-112f include first through sixth object detection sensors (not shown), respectively, and also includes first through sixth charging ports (not shown), respectively.

The enclosure 102 may be of any shape, specifically cylindrical, cube or cuboidal. The enclosure 102 has plurality of openings corresponding to the plurality of carousel assemblies 108. The enclosure 102 is made of at least one of materials such as iron, steel, and aluminium. Each opening has a door of the plurality of doors 104 that provides access to the corresponding carousel assembly. In an embodiment, the first door 104a is hinged at one edge of a first opening of the enclosure 102 and is opened and closed with respect to the hinge as the axis. In another embodiment, the enclosure 102 includes a sliding mechanism to open and close the first door 104a by sliding from an open position to a close position. The first door 104a has a locking mechanism as a first level of security. In an embodiment, the first door 104a has a timer sensor to retain the first door 104a in the open position for a predefined time interval. Once the time exceeds the predefined time interval period, the first door 104a closes in order to prevent unauthorized access to the storage and retrieval system 100. In another embodiment, the first door 104a has a safety sensor that detects the presence of any object that obstructs the path of the first door 104a. This allows an additional assembly of safety to the user while the device 100 is in operation. Any mechanism that helps in automatic opening and closing of the first door 104a can be integrated in the storage and retrieval system 100. In an embodiment, the enclosure 102 has wheels 110—two of which are shown—first and second wheels 110a and 110b to move the entire storage and retrieval system 100 from one place to another. The second through fourth doors 104b-104d are similar to the first door 104a in structure and function. In an embodiment, the first through fourth doors 104a-104d are made of materials such as steel, aluminium, and iron.

The first through fourth carousels assemblies 108a-108d are vertically stacked i.e., placed one above the other and rotate independent of each other with a common axis. In an embodiment, the plurality of carousel assemblies 108 are mounted around a cylindrical shaft 114 with a tray base (not shown), as shown in FIG. 1D. The first carousel assembly 108a is cylindrical in shape and includes the first through sixth storage compartments 112a-112f. Each of the plurality of storage compartments 112 of the first carousel assembly 108a may be of sector-shape or trapezoidal or a triangular shape. One of the plurality of storage compartments 112 is configured as a home position compartment for the first carousel assembly 108a. As shown in FIG. 1D, the storage compartment 112a is configured as the home position compartment. In an embodiment, the storage and retrieval system 100 includes a first locating means (not shown) for detecting the location of the home position compartment of the first carousel assembly 108a. The second through fourth carousel assemblies' 108b-108d are similar to the first carousel assembly 108a in structure and function.

In an embodiment, the system 100 stores the information of availability of the storage compartments in the memory. Depending on the availability of the storage compartments, the system allocates a storage compartment for the storage of goods. In another embodiment, a first object detection sensor detects the presence of an object stored in the first storage compartment 112a and generates a first object detection signal. The first object detection signal indicates whether the first storage compartment 112a is empty and hence, available for storage or whether it is occupied and hence, unavailable for storage. The first object detection sensor is a piezoelectric sensor or an IR sensor that detects the presence of the object stored in the first storage compartment 112a. In an embodiment, the first storage compartment 112a has a door as a second level of security for storage. In an embodiment, the first storage compartment 112a has a port for charging an electronic device such as a mobile phone and a tablet placed in the first storage compartment 112a. In an embodiment, the electronic devices are charged wirelessly. A wireless charger for mobile phones is an inductive charger or a charger that transmits electrical energy by way of radio-frequency waves or microwaves. In an embodiment, the charging port performs the work of an object detection sensor and detects the presence of an electronic device in the first storage compartment 112a. The second through sixth storage compartments 112b-112f are similar to the first storage compartment 112a in structure and function.

The processor is electrically coupled to the locating means corresponding to each of the plurality of carousel assemblies 108 to receive the locations of the home position compartments of the plurality of carousel assemblies 108. The processor is further connected to the object detection sensors corresponding to the plurality of storage compartments 112 of each of the plurality of carousel assemblies 108 to receive the corresponding object detection signals. The processor is also connected to the input device 106b and the authentication device 106c to receive the input from the user and a user identification (ID) information. At the time of storage, the processor determines an empty storage compartment based on the object detection signals. If more than one storage compartment is empty, the processor determines the storage compartment that is nearest to the door 104a as the allocated storage compartment so that minimum amount of rotation of the carousel assembly 108a including the allocated storage compartment is required. Further, the processor stores the user ID information along with the carousel assembly information, and the allocated storage compartment information. In an embodiment, the carousel assembly information and the storage compartment information includes a number or an identification (ID) of the carousel assembly and the storage compartment, respectively.

At the time of retrieval, the processor determines the required storage compartment corresponding to the user based on the user identification information. The processor determines the positions of the plurality of storage compartments 112 based on the location of the home position compartment. The processor then calculates the amount of rotation of the carousel assembly 108a and generates a motor-control signal so that the motor drives the carousel assembly 108a to present the required storage compartment in registry with the opening.

In an embodiment, a monitoring system is employed that ensures that the system 100 is monitored to prevent tampering by any individuals. The monitoring system is composed of an overhead camera. The overhead camera is used for continuous surveillance. In another embodiment, there is at least one modular carousel assembly with a set of radially disposed sector-shaped or rectangular-shaped storage compartments. This allows the user to have customizability with respect to design as well as ease in transportation. Another advantage conferred by the modular design is the subsequent reduction in cost of manufacture and assembly.

In an embodiment, the storage and retrieval system 100 is powered using a battery. In another embodiment, the storage and retrieval system 100 is powered using a power supply. Thus, the system 100 can operate in places with or without access to power. In an embodiment, a user requires to store a mobile phone or some other object in the storage and retrieval system 100.

In the storage and retrieval system 100, the first storage compartment 112a of the first carousel assembly 108a is at home position. Say that the fourth and fifth storage compartments 112d and 112e of the first carousel assembly 108a are empty. During a storage access request, the user enters number of compartments required and the processor allocates the nearest unassigned storage compartment to the user by rotating the storage compartment near the access door. The processor determines that the fourth and fifth storage compartments 112d and 112e are empty and that the fifth storage compartment 112e is nearer to the door of the enclosure 102. The processor then calculates the angular displacement of the first carousel assembly 108a so that either of fourth or fifth storage compartments reaches the home position. Hence, the processor allocates the fifth storage compartment 112e for the user. The processor then outputs the motor-control signal to the motor corresponding to the first carousel assembly 108a. The motor rotates the first carousel assembly 108a to place the allocated fifth storage compartment 112e in front of the door 104a of the enclosure 102. A similar action is undertaken for the next carousel assembly if the compartments in the previously accessed assembly are occupied. The processor de-activates the lock-control signal to unlock the door 104a so that the user can access the fifth storage compartment 112e to store the object.

Further, the processor activates the timer when the door 104a is unlocked. The processor also activates the door mounted sensor to perceive the presence of objects obstructing the access door and actives the lock-control signal to lock the door 104a after a predetermined time is passed. The charging port in the fifth storage compartment 112e allows the mobile phone to charge. The fifth storage compartment 112e is made of material that allows easy absorption of vibrations of the mobile phone.

During a retrieval access request, the processor compares the user identification information that is received from the user by way of the interface with the list of user identification information that is stored in the memory. If the user identification information matches with at least one of the user identification information stored in the memory, the processor identifies the fifth storage compartment 112e corresponding to the identified user identification information to retrieve the mobile phone. Hence, the processor outputs the motor-control signal to the motor corresponding to the angle required to place the identified fifth storage compartment 112e in front of the door 104a. The motor rotates the first carousel assembly 108a and places the identified fifth storage compartment 112e in front of the door. The processor de-activates the lock-control to unlock the door 104a so that the user can access the fifth storage compartment 112e for retrieving the mobile phone. In another embodiment, a mobile phone jammer is positioned on the storage and retrieval system 100 to block transmission or reception of signals by creating a form of interference at the same frequency ranges that mobile phones use. In yet another embodiment, a scanner is positioned near one of the doors of the storage and retrieval system 100 to scan objects for security screening purposes before they are placed in the system 100. The scanner may be one of, but not limited to, x-ray scanner or wave scanner.

In an embodiment, the storage and retrieval system 100 may connect to the Internet via a variety of different networks. For example, the system 100 may connect to the Internet via a Wireless Local Area Network (Wi-Fi), a wired Local Area Network, or a cellular data network. The system 100 may be integrated with an automated slot booking system (not shown). The automated slot booking system may include one or more web servers (not shown) and application servers (not shown). For convenience, the web server may provide a graphical web user interface through which users may interact with the automated slot booking system. The automated slot booking system may be an online i.e., web-based system and an application-based system. The automated slot booking system allows the user to schedule a time slot for storage access or retrieval access of the storage and retrieval system 100. The automated slot booking system generates a code corresponding to booked time slot for the user. The user can visit the storage and retrieval system 100 to access it using the generated code. Moreover, the generated code is valid for a limited time period. This automated slot booking system allows the user to avoid registration steps at the location of the storage and retrieval system 100.

The storage and retrieval system 100 is portable and efficient system which is capable of providing secure storage system to more than one user. Moreover, the storage and retrieval system 100 provides a storage place to a user that is secured from other users. Thus, the multiple levels of security provided in the storage and retrieval system 100 prevents the risk of unauthorized access to a user's device. Further, the storage and retrieval system 100 provides an automated identification and allocation of at least one compartment that avoids manual navigation and prevents the hassle of remembering and searching for the compartment. The storage and retrieval system 100 provides a facility to charge electronic devices such as mobile phones and tablets when kept in the storage.

The present invention has been described herein with reference to a particular embodiment for a particular application. Although selected embodiments have been illustrated and described in detail, it may be understood that various substitutions and alterations are possible. Those having ordinary skill in the art and access to the present teachings may recognize additional various substitutions and alterations are also possible without departing from the spirit and scope of the present invention, and as defined by the following claims.

We claim:

1. A storage device for storing goods for subsequent retrieval, the storage device comprising:
a carousel assembly having a plurality of storage compartments that are arranged around a central axis;
an enclosure for housing the carousel assembly, wherein the enclosure has a door that allows access to one of the plurality of storage compartments at an instant of time;
a first drive mechanism for rotating the carousel assembly;
a second drive mechanism for opening and closing the door;
an authentication device attached to the enclosure for authenticating a user prior to storing and retrieving the goods; and
a control system connected to the first drive mechanism, the second drive mechanism, and the authentication device for controlling the movements of the door and the carousel assembly, wherein when the user is authenticated for storing goods in the storage device, the control system determines a displacement of each of the plurality of storage compartments from a storage compartment that is at a home position and dynamically allocates at least one storage compartment of the plurality of storage compartments to the user.

2. The storage device of claim 1 further comprising a plurality of object detection sensors, wherein each of the plurality of object detection sensors is mounted in the corresponding storage compartment of the plurality of storage compartments for detecting the presence of the goods.

3. The storage device of claim 1 further comprising a safety sensor attached to the door for detecting the presence of an object that obstructs movement of the door.

4. The storage device of claim 1, wherein the authentication device is at least one of a biometric scanner, a password authentication, and a bar-code scanner.

5. The storage device of claim 1, wherein the carousel assembly and the enclosure are made of at least one of steel, aluminium, and iron.

6. The storage device of claim 1, wherein the first drive mechanism includes a motor that is mounted in the enclosure for rotating the carousel assembly.

7. The storage device of claim 1, wherein each of the plurality of storage compartments is equipped with chargers for charging the goods that are electronic devices.

8. The storage device of claim 1 is portable.
